(19) United States
(12) Patent Application Publication
(10) Pub. No.: US 2008/0247069 A1
(43) Pub. Date: Oct. 9, 2008

(54) LINEAR TENSIONED MEMBRANE REFLECTOR

(76) Inventor: Allen I. Bronstein, Inverness, CA (US)

Correspondence Address: Jill L. Robinson, 95 Shuey Drive, Moraga, CA, 94556, US

(21) Appl. No.: 12/062,410

(22) Filed: Apr. 3, 2008

Related U.S. Application Data
(63) Continuation-in-part of application No. 60/910,076, filed on Apr. 4, 2007.

(51) Int. Cl. G02B 7/182

(52) U.S. Cl. 359/871

(57) ABSTRACT

An improved solar reflector utilizing end forms supporting a tensioned reflective membrane, where the end forms have a corrected periphery shape different from the ideal cross sectional shape of the reflector, that produces the idea cross sectional shape along most of the tensioned membrane, and with additional means to increase structural rigidity along the lateral free edges of the reflective membrane.

### CROSS-REFERENCE TO RELATED APPLICATIONS

This invention is a continuation-in-part of provisional patent application 60/910,076, which is incorporated by reference herein.

### BACKGROUND OF THE INVENTION

The invention relates to a solar reflector in the nature of an arcuate, generally parabolic, surface which concentrates solar radiation upon an energy absorbing target which is located at the focus of the parabola. Specifically, the present invention relates to improvements to the design of linear tensioned membrane solar reflectors that significantly improve the optical properties of the design based upon the inventor's understanding of how linear tensioned membranes behave and what modifications to the design are required to improve their optical accuracy.

Linear tensioned membrane reflectors have many advantages over more traditional designs incorporating ridged frame structures. They are relatively light and easy to assemble. In part because of the lightweight, multiple reflectors can be mounted on a single frame structure which can be balanced on a single pillow block allowing for tilting adjustments to be made with minimal energy expended.

However, linear tensioned membrane reflector technology presents certain problems that don't exist for linear solar reflector technologies constructed with a rigid structural frame structures. For reflectors with a rigid structural frame, the mirrored reflector surface, either glass or reflective film, is adhered to a rigid metal substrate supported by torque tube and ribs or a space frame-type structure without concern for the mirror element's structural strength or mechanical properties.

In contract, a trough-shaped linear tensioned membrane reflector usually comprises a frame structure with parallel-facing identical form members, each describing the desired cross-sectional shape of the reflector. A membrane of highly reflecting material is wrapped tightly around the edges of the form members and the membrane is then placed under 1000 to 7000 pounds per square inch (PSI) of tension in one direction, usually by moving one of the members away from the other.

For example, U.S. Pat. No. 4,293,192, issued Oct. 6, 1981, to Allen I. Bronstein, sets forth a solar reflector which is collapsible and portable and which will maintain its true configuration without the requirement of supporting ribs. The invention of this patent includes the use of a slideway on which two form members are supported, the forms members having identical surfaces around a portion of their peripheries, which identical surfaces conform precisely to the desired configuration of the reflecting surface. A reflective membrane is wrapped tightly around the surfaces and secured in place, and at least one of the forms is mounted on a slide which is moved away from the other form until the flexible sheet is in tension. Thereby, the flexible sheet is intended to conform precisely to the curvature of the form surfaces over its full length. The slideway is pivoted on support legs so that it may be tilted sideways at a selected angle, depending on the angle of the sun. Strips of tape may be adhered to the outer or convex surface of the material to dampen it against wind vibration.

Similarly, U.S. Pat. No. 4,510,923, issued Apr. 16, 1985 to Allen I. Bronstein, sets forth a tensioned solar reflector which comprises a longitudinally extending frame structure having first and second frame ends and a second end closure. A first form member is inboard of the first end. A second form member is parallel to the first form member and inboard of the second end closure. The form members have peripheries having identical form surfaces along portions thereof. A support member is attached to either the second end closure or the second form member and is adapted for transferring the weight of the second form member to the second end closure. A reflective membrane has its opposite edges secured to the identical form surfaces. Stretching means stretch the membrane between the first and second form members and into the desired, generally parabolic, shape. Further, after the membrane is placed under tension, stiffening strips are preferably attached to the lateral edges of the membrane by being bonded thereto by an appropriate adhesive.

Notwithstanding the improvements the above inventions made over the prior art, the inventor noticed that all such flexible membrane-type reflectors sometimes deviate from the desired, usually parabolic, cross-sectional shape because of distortion at the free lateral edges of the membrane. This deviation can cause significant loss in optical accuracy and thus the performance of the reflector, particularly in large reflectors where the weight and easy construction advantages of the membrane-type reflector are especially significant.

The distortion is caused primarily by two factors. First, when tension is placed on a membrane in only one direction, there is often a non-uniform the distribution of the forces, especially near the unattached lateral edges of the membrane. This non-uniform distribution of force across the surface of the membrane causes the membrane to vary from the desired cross-sectional shape described by the end form of the reflector. Second, the unsupported edges of the membrane have a tendency to return to a flat shape in a manner similar to that of the edge of a rolled piece of paper held at both ends: towards the center, where the paper is not held, the edge of the paper will attempt to flatten, gapping and distorting from the shape at the ends. Placing the membrane under tension in one direction does not affect this distortion.

The inventor noticed that the behavior of the change in the cross-sectional shape of the reflector is very consistent: it occurs almost immediately, typically within only a few inches from an end form, and remains constant until the membrane reaches another end form.

### BRIEF SUMMARY OF THE INVENTION

The invention comprises correcting the cross-sectional profile of the end forms from the selected ideal cross-sectional shape. The correction may be effected by a number of methods. Additionally, a free edge support structure for the membrane is provided. By combining an end form profile/periphery correction with a free edge support structure, a very large, strong and accurate solar reflector can be made without significantly increasing weight or cost. For example, in a parabolic trough measuring 40″ wide×24 feet long, the inventor found that the distortion for that particular trough measured about 4 inches deep from each free edge. Thus, a total of about 20% of the light was not hitting the receiver tube. By adjusting the end forms' cross-sectional shape in the manner proposed by the invention, there was an improvement of almost 20% in the reflector's ability to focus light onto the receiver tube.

It should be noted that many of the reflective films utilized in solar reflector technologies, such as 3M's ECP-305+ acrylic silver film, do not posses the dimensional stability and tensile strength that are required of a membrane under tension. By creating special laminates made by laminating these reflective films to a metal foil or polymer film, like Polyester (PET), the required mechanical attributes are obtained.

### BRIEF DESCRIPTION OF THE SEVERAL VIEWS OF DRAWINGS

FIG. 1 shows a top view of a tensioned membrane solar reflector without the improvement of the current invention.

FIG. 2 shows a second view of a tensioned membrane solar without the improvement of the current invention.

FIG. 3 is a cross-sectional view of the tensioned membrane solar reflector shown in FIG. 2, showing the desired correction to the cross-section profile.

FIG. 4 is a cross-sectional view of a tensioned membrane solar reflector with out the improvement of the current invention, showing the effect of adding a rigid structural element to the lateral edge of the membrane.

FIG. 5 shows a perspective view of a tensioned membrane solar reflector

FIG. 6 shows the method for determining the shape of the end forms necessary to create the desired cross-sectional shape of the membrane.

FIG. 7 shows a first alternative for increasing the structural rigidity of the membrane by folding.

FIG. 8 shows a second alternative for increasing the structural rigidity of the membrane by rolling.

FIG. 9 shows a third alternative for increasing the structural rigidity of the membrane using a side structural member.

FIG. 10 shows an attachment detail for the method shown in FIG. 9.

FIG. 11 shows a fourth alternative for increasing the structural rigidity of the membrane using a tensioned cable.

FIG. 12 shows a first alternative for attachment of the membrane in a tensioned cable design.

FIG. 13 shows a second alternative for attachment of the membrane in a tensioned cable design.

FIG. 14 shows a third alternative for attachment of the membrane in a tensioned cable design.

FIG. 15 shows a first view of the detail of the attachment to the side structural member.

FIG. 16 shows a second view of the detail of the attachment to the side structural member.

### DETAILED DESCRIPTION OF THE INVENTION

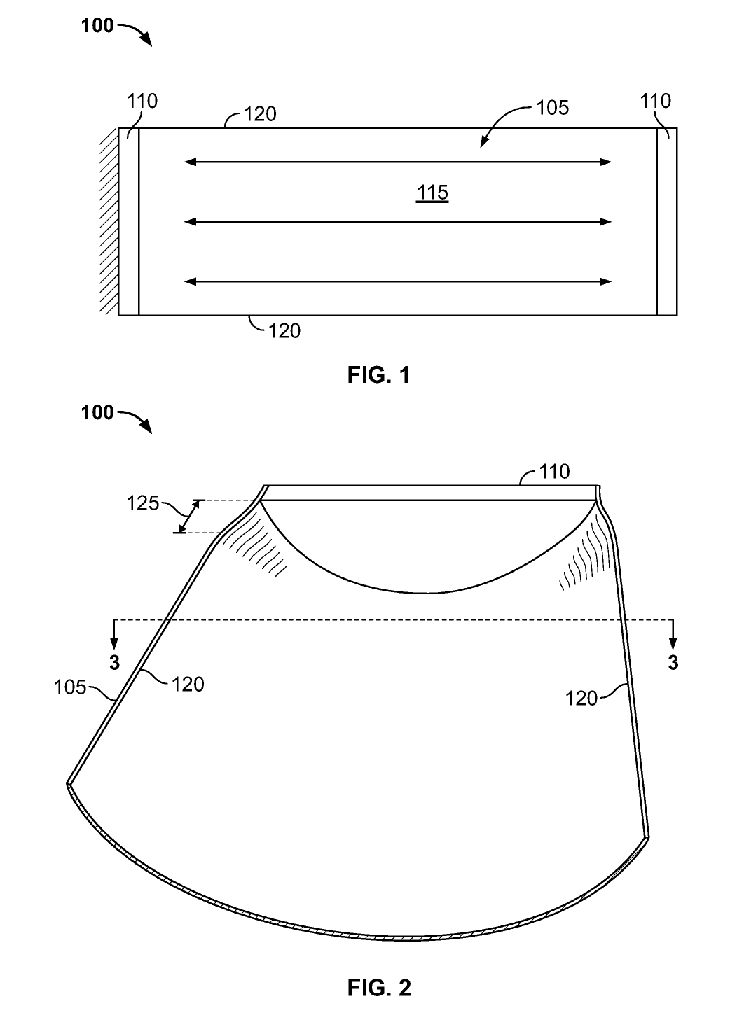

FIGS. 1-3 show a linear tensioned membrane solar reflector 100 without the improvement of the current invention. The membrane 105 is wrapped tightly around the end forms 110 and secured in place. Usually, the end forms 110 are in the shape of the ideal cross-sectional shape, such as a parabola. The membrane 105 is placed under a tensioning force 115 in one direction. The lateral free edges 120 of the membrane 105 change shape as they leave the sphere of influence of the end forms 110, causing a distortion in the profile, typically stabilizing after a short transitional section 125 of only a few inches from the end form 110. Importantly, the distortion 125 typically occurs within a few inches of an end form 110 and then remains fairly constant until the membrane 105 reaches the sphere of influence of another end form 110.

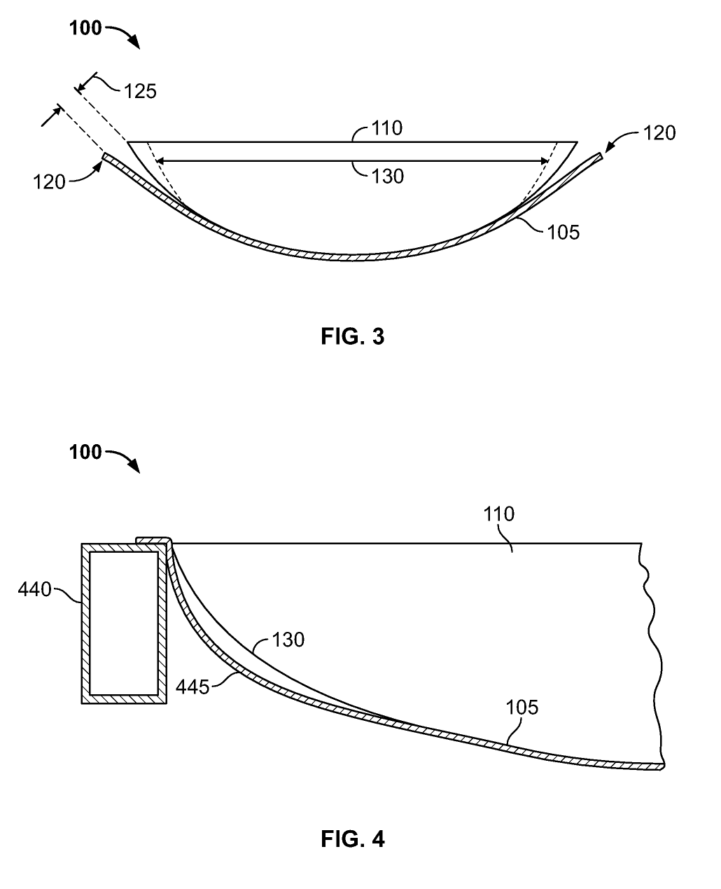

FIG. 3 shows the correction 130 required for the membrane 105 to be in the desired shape for maximum optical efficiency.

FIG. 4 demonstrates that simply attaching the edge of the membrane to a rigid structural element or stiffening strip 440, as is disclosed in U.S. Pat. No. 4,510,923, without modifying the end form 110 shape, does not solve the lateral edge distortion problem. The membrane 105 changes its shape when rigid structural elements or stiffening strips 440 are added, but the cross-section is still distorted 445 from the desired cross-section 130. Thus, although the addition of rigid structural element or stiffening strip 440 is desirable for strengthening the membrane 105 against elemental forces such as wind, the addition of such elements or strips 440 by itself does not correct optical distortions in the reflector 100.

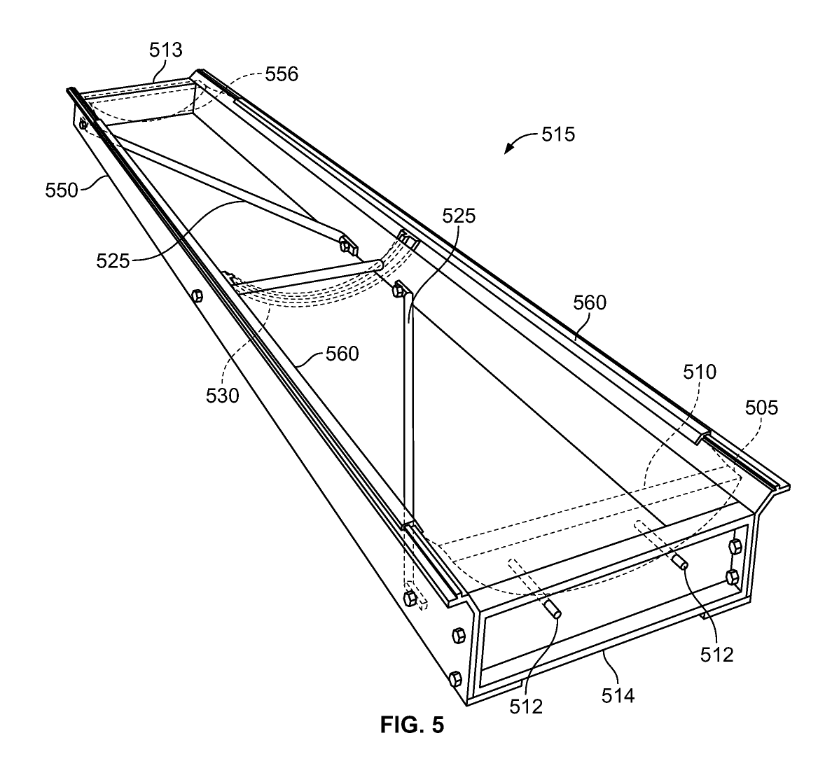

FIG. 5 shows a perspective view of a tensioned membrane solar reflector 500. The membrane 505 is wrapped or otherwise attached to two end forms 556, 510, one of which is fixed 556 and other of which is moveable 510 so as to allow for thermal expansion and contraction of the membrane 505 and the structure generally. The end forms 556, 510 are attached via rods 512 or other means to the fixed and moveable end caps 513, 514 respectively, of a frame support structure 515, which also includes side structural elements 550 and cross-bracing 525. The device may also include a rib or ribs 530 which have the desired cross-sectional shape and which are attached to the membrane at selected intervals between the end forms 556, 510.

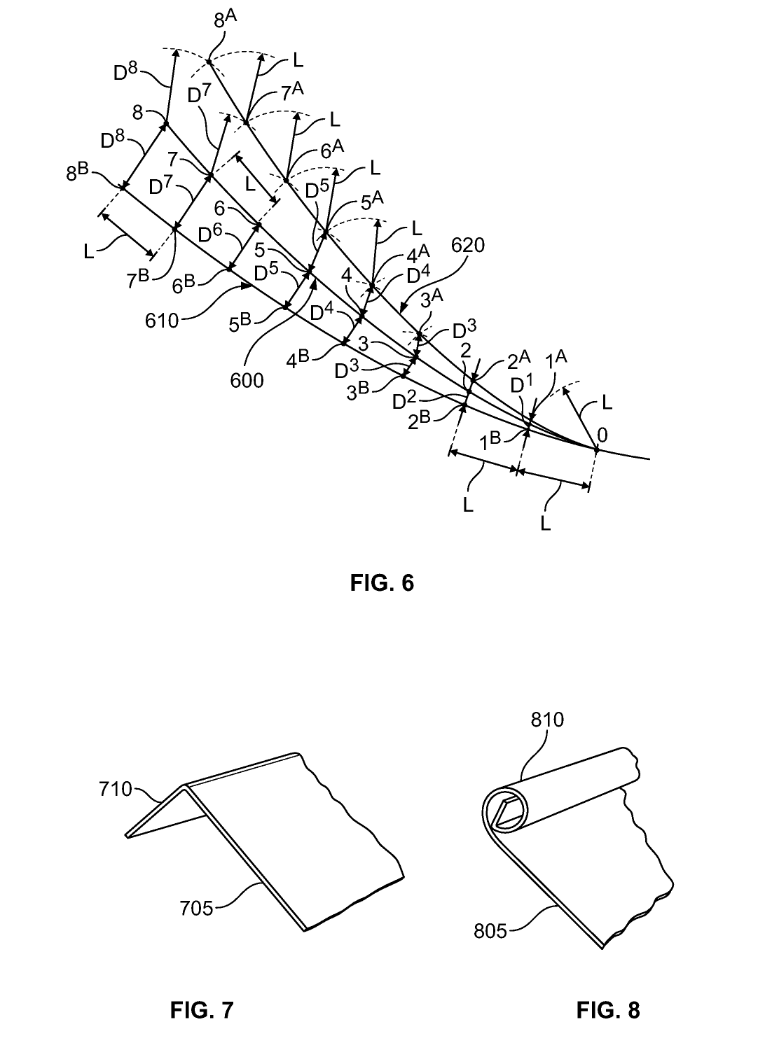

In accordance with the current invention, the primary correction to the design of the reflector in order to achieve improved efficiency must be to modify the shape of the end forms 556, 510. Generally, such correction is effected by measuring the distortion along the reflector when the end forms have the selected ideal cross sectional shape at their peripheries and using those measurements to correct the shape of the end forms. FIG. 6 shows a procedure for determining the corrected cross-sectional profile of the end forms For clarity and simplicity this description uses only eight points to illustrate the principles involved; however, it will be understood by those of ordinary skill in the art that the use of more points will improve the result.

A series of measurements are taken between the ideal cross sectional profile 600 and the actual, distorted profile 610 and checked at various points along the trough's cross-section. All measurements taken are well away from the end forms and the transitional sections 125. In FIG. 6, the length “L” represents a constant fixed distance between points on the surface of the membrane and the periphery of the end form. Those of ordinary skill in the art will appreciate that “L” will be significantly smaller than the perimeter of the cross section, and could be determined by dividing length of one half of the trough perimeter by the number of desired measurement points. All measurements start at the “0” point, which corresponds to the point where the membrane's cross-sectional profile accurately repeats the shape of the end form. A distance D¹ through D⁸ is obtained by measuring the distance between point 1 and 1^{B}, 2 and 2^{B}, and so forth through 8 and 8^{B}. The new corrected cross-sectional profile of the end forms is then plotted in the following manner. An arc is swung with a radius of length “L” from point “0”. A second arc is swung with a radius measuring distance D¹ whose center is point “1” on the end form cross-section. Point 1^{A} is the intersection of the two arcs and the first point of the corrected cross-sectional profile. The second point is plotted by using the constant “L” and distance D². The center point of the second radius “L” is the newly plotted point 1^{A}, and the center point of radius D² is point “2” on the end form cross-section. Repeating this procedure, the center points for the radius “L” become points 2^{A}, 3^{A}, 4^{A}, continuing on through 7^{A}. While the center points for the arc of the radius are D³ through D⁸, its corresponding points on the end form are “3” through “8”. In this manner a very accurate corrected end form cross-sectional profile 620 can be found for any desired shape.

Although it is possible to similarly adjust the shape of the ribs 530, in practice adjustment of the end form 556, 510 profiles are generally sufficient to achieve the desired optical accuracy. This avoids the necessity of spacers and similar devices where the membrane is attached to the ribs 530. Thus, the ribs 530 may have the desired optical profile shape without any correction.

Those of ordinary skill in the art will appreciate that the modifications to the end forms peripheries will result in slight distortions in optical accuracy near the end forms themselves. However, these slight distortions in optical accuracy occurring at the junctions of end forms represented only a 1% to 2% loss of optical efficiency, significantly less than the usual improvement gained by making the modifications to the end form cross sectional shape.

It should be noted that the behavior of the membrane, and thus the necessary corrections, will vary depending upon the membrane's construction, thickness, and composition, and upon the cross-sectional profile of the desired shape (i.e., parabola, circle, straight line, or any other geometric or compound shape that can be generated into a linear reflector.)

In practice, a single reflective metal foil or metalized polymer film as the reflector's membrane presents many limitations when used in a tensioned membrane reflector. These include the limited tensile strength and dimensional stability of the polymer reflectors, the available thickness and/or width of metal foils or polymer films, and the longevity of the materials available. Laminate constructions utilizing metal foils and high strength dimensionally stable polymer films, such as polyester (PET) as the structural element can overcome these limitations, for example: a 5 mil aluminum foil adhered to a 2 mil metalized aluminum polyester reflector; or alternatively a 5 mil to 7 mil polyester (PET) film laminated to a 2 mil metalized silver acrylic (PMMA) reflector film, such as 3M's ECP 305+. Both metal foil and polyester film offer an excellent structural element (substrate) that is dimensionally stable and can support the metalized polymer reflector element of the laminate when under tension. These laminates can be created using standard converting manufacturing processes that simplify membrane manufacture and assembly.

Although the corrections to the end plates are necessary to create the desired cross-section in the reflector, if the membrane's lateral free edges are not protected by a cover, such as the one described in U.S. Pat. No. 4,510,923, the free edges are vulnerable to vibration, cross-sectional deformation, and damage by wind loading which can also affect the efficiency of the reflector. To prevent this requires an increase in the structural rigidity and strength if a cover is not used.

One method of creating such additional structural integrity is to fold 710 or roll 810 the edge of the membrane 705, 805 as shown in FIGS. 7 and 8.

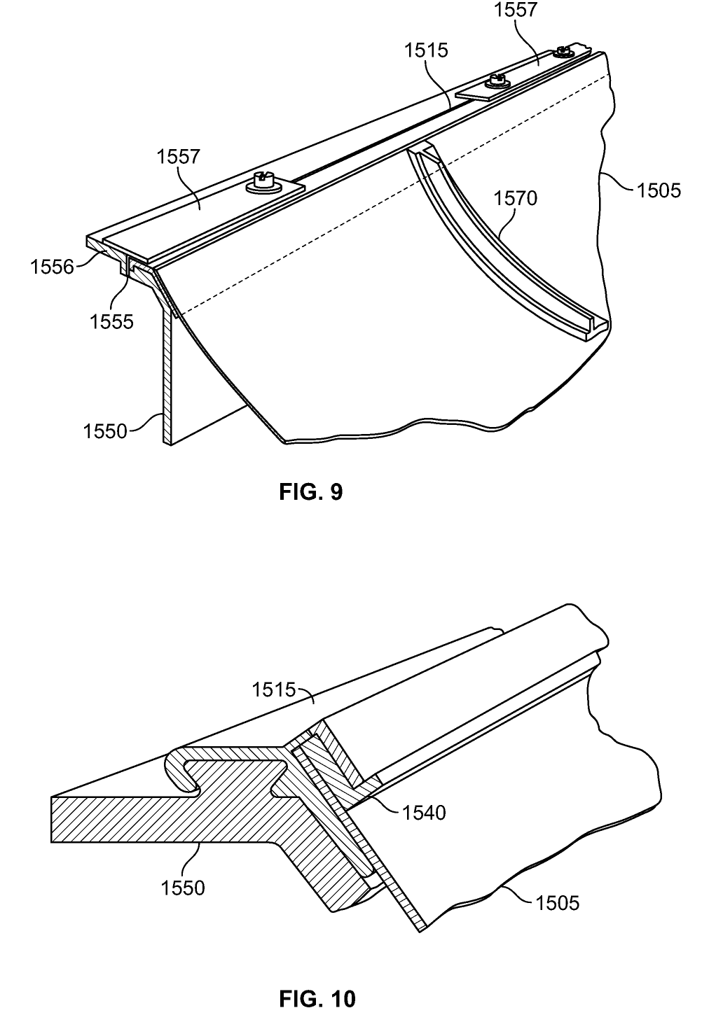

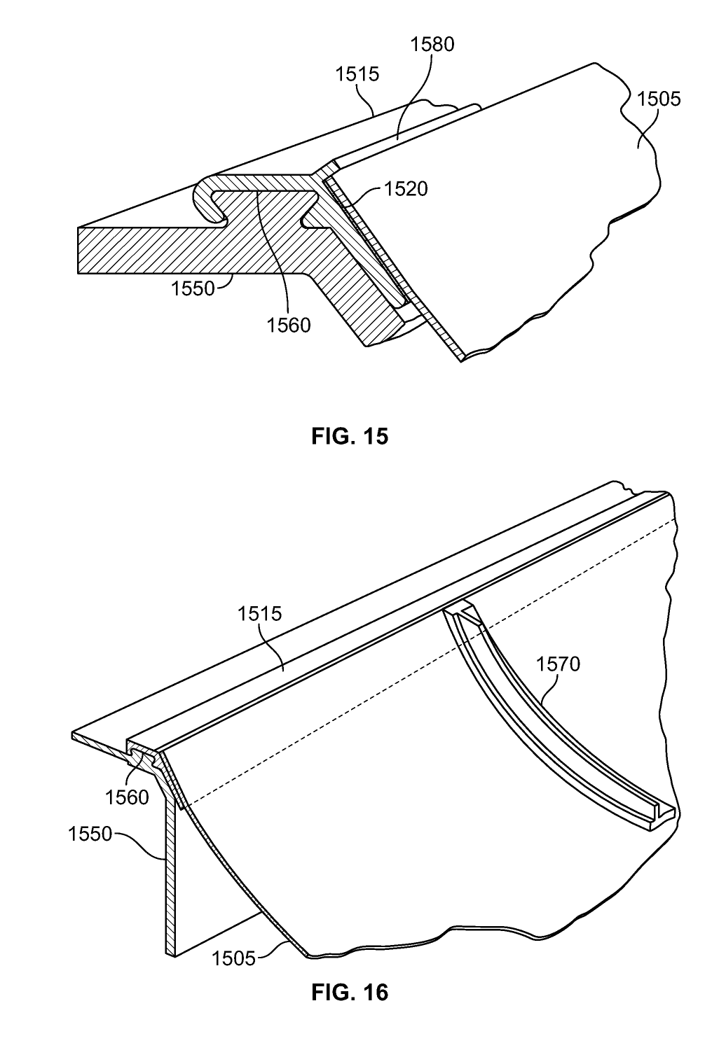

With reference to FIGS. 9-10 and 15-16, another means of giving structural strength and integrity to the lateral free edges is to use a separate lateral edge support structural element 1550, for example, either a substantially rigid member or a tensioned cable, that is preferably slideably attached to the membrane 1505 edges.

Where the structural element 1550 makes contact with the membrane 1505 the cross-sectional profile must match the desired optical shape of the reflector. The free lateral edges of the membrane 1505 are attached to a sliding stiffening element 1515 either by adhesive 1520 as shown in FIGS. 15 and 16 or mechanical means, such as a wedge shaped spline 1540 as shown in FIG. 10. The sliding stiffening element 1515 is attached to the structural element 1550 by means of a freely sliding spline 1555 or dovetail arrangement 1560 that allows the sliding stiffening element 1515 to freely move laterally to compensate for thermal expansion and contraction.

With reference to FIGS. 5, 9 and 16, the membrane 505, 1505 is attached to the rib 530, 1570 and structural element 550, 1550. The sliding stiffening element 560, 1515 is not attached to the membrane 505, 1505 at the transitional areas of the membrane where the end forms 556, 510 cross-section influences and distorts its shape. The sliding stiffeners 560, 1515, structural elements 1550, fixed 513 and moveable end caps 514, ribs 530, 1570, end forms 556, 510, and diagonal cross bracing 525 that create a lightweight yet rigid structure. The fixed end cap 513 of the free edge support structure is securely attached to the fixed end form 556, while the movable end cap 514 is hung on rods 512 protruding from the movable end form 510, allowing the frame support structure 515, as noted above, to freely move laterally back and forth to compensate for thermal expansion and contraction.

FIGS. 15 and 16 shows one means of attaching the sliding stiffener 1515 to the structural element 1550, specifically, a dovetail slide 1560. The membrane 1505 is attached to the sliding stiffener 1515 with adhesive 1520. The profile of the sliding stiffener 1515 includes a stop 1580 for accurately positioning the membrane 1505 on the stiffener 1515. Alternatively, with reference to FIG. 9, a sliding spine arrangement may be employed where the sliding spline 1555 freely slides in a slot or indentation 1556 on the structural element 1550. The sliding spline stiffener 1515 is held in its slot 1556 by a top cap 1557 that is screwed to the structural element 1550. A small gap is created by the difference in thickness between the sliding spline stiffener 1515 and the top of the structural element 1550; this allows the sliding spline stiffener to move freely.

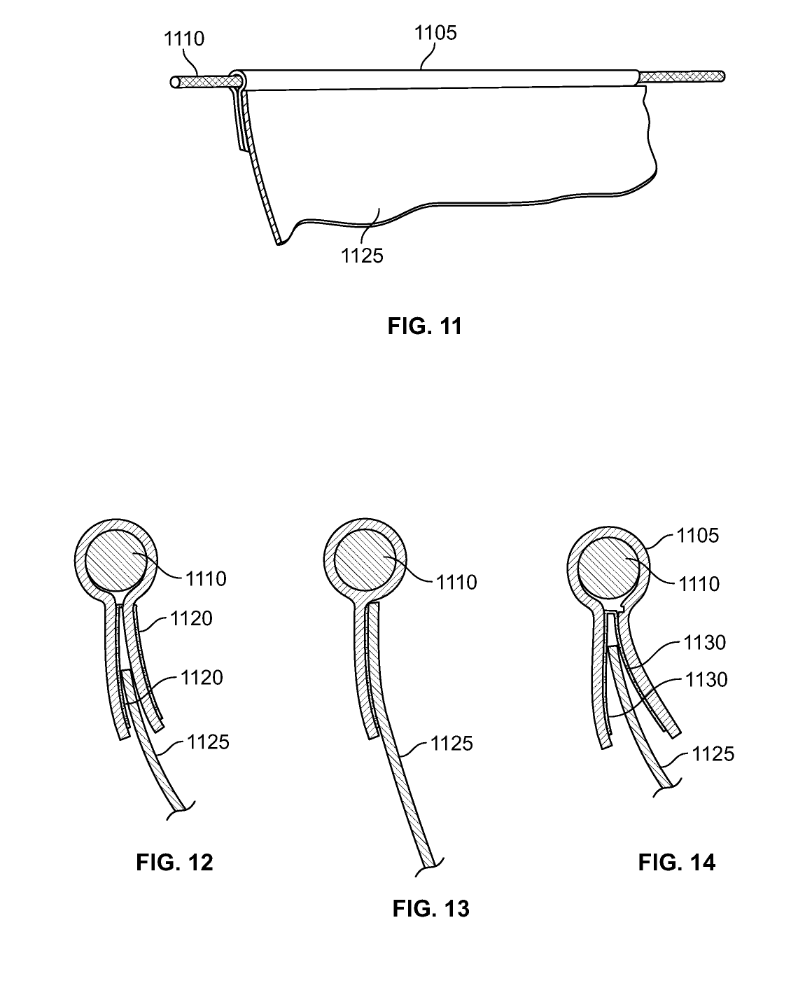

With reference to FIGS. 11-14, another means of giving structural strength and integrity to the free edge of the membrane is to use a tensioned cable that is attached to the reflector tensioning structure. A sliding stiffener membrane cable attachment is shown in FIG. 11. FIGS. 12-14 show three alternate methods of attaching the free edge of the membrane 1125 to the sliding stiffener. FIGS. 12 and 14 show a split design where the sliding stiffener 1105 slips over the tensioned cable 1110 and then adheres to itself and the membrane by means of an adhesive 1120. FIG. 13 shows another method where the cable 1110 is inserted through the hole in the sliding stiffener 1105 and then tensioned. FIGS. 12 and 13 show the membrane 1125 being adhered to the exterior of the sliding stiffener 1105, and FIG. 14 shows an internal stop and internal fastening.

Thus, by combining the cross-sectional end form profile correction with a free lateral edge support means, a very large, strong, and accurate low cost solar reflector can be made. While the present invention has been shown and described with reference to the foregoing preferred embodiments, it will be apparent to those skilled in the art that changes in form, connection, and detail may be made therein without departing from the spirit and scope of the invention as defined in the appended claims.

I claim:

1. In a solar reflector comprising a support structure, a first form member attached to said support structure having a first periphery and a second form member attached substantially parallel to the first form member having a second periphery substantially identical to the first form member, said first and second form members having substantially identical form surfaces defined by at least a portion of the first and second peripheries; a tensioned membrane having a reflective in-facing surface having opposite edges attached to the form surfaces and having lateral edges generally perpendicular to the first and second form members, whereby the tensioned membrane defines a cross sectional shape substantially parallel to the identical form surfaces of the first and second form members; a method for determining the shape of the first and second peripheries comprising the steps of: Selecting the ideal cross sectional profile for the solar reflector;
Causing the first and second peripheries to have the shape of the ideal cross sectional profile;
Selecting a length L which is substantially smaller than the length of the first and second peripheries;
Taking a plurality of distance measurements D¹ through Dⁿ at multiples of length L, L¹ through Lⁿ, between the ideal cross sectional profile and the cross sectional shape of the tensioned membrane, beginning at a point away from the first and second end forms, where the difference between the ideal cross sectional profile and the cross sectional shape of the tensioned membrane is zero;
Determining points on the corrected end form peripheries by
swinging a first arc of radius length “L” from point “0”;
swinging a second arc of radius D¹ whose center is point is distance L¹ along the ideal cross sectional profile from point “0”;
identifying the intersection of the first and second arc as point C¹;
swinging a third arc of radius length “L” from point C¹;
swinging a fourth arc of radius D² whose center is point is distance 2L along the ideal cross sectional profile from point “0”;
identifying the intersection of the third and fourth arc as point C²;
repeating the process of swinging an arc of radius length “L” from point Cⁿ⁻¹; swinging an arc of radius length Dⁿ whose center is point is distance nL along the ideal cross sectional profile from point “0”; and identifying the intersection as point Cⁿ;
Interpolating between points 0 and C¹-Cⁿ to create the corrected first and second end form peripheries.

2. A solar reflector comprising:
a support structure;
a first form member attached to said support structure having a first periphery and a second form member attached substantially parallel to the first form member having a second periphery substantially identical to the first form member, said first and second form members having substantially identical form surfaces defined by at least a portion of the first and second peripheries;
a tensioned membrane having a reflective in-facing surface having opposite edges attached to the form surfaces and having lateral edges generally perpendicular to the first and second form members, whereby the tensioned membrane defines a selected ideal cross sectional shape substantially parallel to the identical form surfaces of the first and second form members; and wherein the peripheries of the first and second form members are different from the ideal cross sectional shape and are selected to produce the ideal cross sectional shape along the tensioned membrane at points distanced from the opposite edges.

3. The solar reflector of claim 2 wherein the peripheries of the first and second form members are corrected by selecting the ideal cross sectional profile for the solar reflector;
causing the first and second peripheries to have the shape of the ideal cross sectional profile;
selecting a length L which is substantially smaller than the length of the first and second peripheries;
taking a plurality of distance measurements D¹ through Dⁿ at multiples of length L, L¹ through Lⁿ, between the ideal cross sectional profile and the cross sectional shape of the tensioned membrane, beginning at a point away from the first and second end forms, where the difference between the ideal cross sectional profile and the cross sectional shape of the tensioned membrane is zero;
determining points on the corrected end form peripheries by
swinging a first arc of radius length “L” from point “0”;
swinging a second arc of radius D¹ whose center is point is distance L¹ along the ideal cross sectional profile from point “0”;
identifying the intersection of the first and second arc as point C¹;
swinging a third arc of radius length “L” from point C¹;
swinging a fourth arc of radius D² whose center is point is distance 2L along the ideal cross sectional profile from point “0”;
identifying the intersection of the third and fourth arc as point C²;
repeating the process of swinging an arc of radius length “L” from point Cⁿ⁻¹; swinging an arc of radius length Dⁿ whose center is point is distance nL along the ideal cross sectional profile from point “0”; and identifying the intersection as point Cⁿ;
interpolating between points 0 and C¹-Cⁿ to create the corrected first and second end form peripheries.

4. In a solar reflector comprising a support structure, a first form member attached to said support structure having a first periphery and a second form member attached substantially parallel to the first form member having a second periphery substantially identical to the first form member, said first and second form members having substantially identical form surfaces defined by at least a portion of the first and second peripheries; a tensioned membrane having a reflective in-facing surface having opposite edges attached to the form surfaces and having lateral edges generally perpendicular to the first and second form members, whereby the tensioned membrane defines a cross sectional shape substantially parallel to the identical form surfaces of the first and second form members; a method for determining the shape of the first and second peripheries comprising the steps of:
Selecting the ideal cross sectional profile for the solar reflector;
Causing the first and second peripheries to have the shape of the ideal cross sectional profile;
Measuring the differences between the actual cross sectional profile of the solar reflector and the ideal cross sectional profile of the solar reflector at points distant from the first and second form members;
Using the measured differences to modify the first and second peripheries.

5. The solar reflector of claim 2 further comprising a means for increasing the structural rigidity of the lateral edges.

6. The solar reflector of claim 5 wherein the means for increasing the structural rigidity of the lateral edges comprises folding the lateral edges.

7. The solar reflector of claim 5 wherein the means for increasing the structural rigidity of the lateral edges comprises rolling the lateral edges.

8. The solar reflector of claim 5 wherein the means for increasing the structural rigidity of the lateral edges comprises a lateral edge support structural element attached to the lateral edges of the membrane.

9. The solar reflector of claim 8 wherein the lateral edge support structural element comprises a substantially rigid member.

10. The solar reflector of claim 8 wherein the lateral edge support structural element comprises a tensioned cable.

11. The solar reflector of claim 2 wherein the tensioned membrane comprises a laminate comprising a substrate and a metalized polymer reflector element, and wherein the substrate is selected from the group consisting of a dimensionally stable polymer film and a metal foil.

12. The solar reflector of claim 11 wherein the metalized polymer reflector element comprises metalized aluminum polyester and the substrate comprises aluminum foil.

13. The solar reflector of claim 11 wherein the metalized polymer reflector element comprises metalized silver acrylic film and the substrate is polyester.

14. The solar reflector of claim 8 further comprising a sliding stiffening element attached to the lateral edges of the membrane and slideably mounted to the lateral edge support structural element.

15. The solar reflector of claim 9 further comprising a sliding stiffening element attached to the lateral edges of the membrane and slideably mounted to the substantially rigid member.

16. The solar reflector of claim 10 further comprising a sliding stiffening element attached to the lateral edges of the membrane and slideably mounted to the tensioned cable.

17. The solar reflector of claim 11 wherein the metalized polymer reflector element comprises metalized aluminum polyester and the substrate comprises metal foil.
